(19) United States
(12) Patent Application Publication
(10) Pub. No.: US 2019/0160697 A1
(43) Pub. Date: May 30, 2019

(54) Low Sticking Friction Knife Blade and Methods of Manufacturing Same

(71) Applicant: HENRY JOHNSON PTY LTD AS TRUSTEE FOR THE HENRY JOHNSON FAMILY TRUST, Kenmore Hills (AU)

(72) Inventor: MARK JAMES HENRY, Antibes (FR)

(21) Appl. No.: 16/199,352

(22) Filed: Nov. 26, 2018

Related U.S. Application Data
(60) Provisional application No. 62/590,840, filed on Nov. 27, 2017.

(51) Int. Cl. B26B 9/02; B23P 15/28; B26B 3/02

(52) U.S. Cl. CPC B26B 9/02; B26D 2001/006; B26B 3/02; B23P 15/28

(57) ABSTRACT

The knife blade has a side portion proximate the cutting edge which includes a series of adjacent lengthwise corrugations. Each corrugation includes an inclined surface with an edge which extends outwardly beyond the inclined surface of the adjacent corrugation forming a ridge along the corrugation. Food, as it is sliced by the blade, moves across the inclined surface and over the ridge of each corrugation, to release the vacuum formed between the food and the blade, reducing the tendency of the food to stick to the blade. The knife is formed by forming a blade blank with corrugations on one side and metal strips on the opposite side. The metal strips are ground off the opposite side and the corrugated side proximate the edge is lightly ground to form a chisel edge. The blank may be formed by casting 3D printing, forging, extrusion, pressing or another additive manufacturing process.

### CROSS-REFERENCE TO RELATED APPLICATIONS

Priority is claimed on Provisional Patent Application Ser. No. 62/590,840, filed Nov. 27, 2017, which is incorporated herein in its entirety by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

### 1. Field of the Invention

The present invention relates to a knife and more particularly to a knife with a low sticking friction blade and methods for manufacturing same.

### 2. Description of Prior Art Including Information Disclosed Under 37 CFR 1.97 and 1.98

An old source of frustration for cooks has been the tendency for cut pieces of food to adhere to the blades of their kitchen knives. The stuck slice of detached food can interfere with the view of the food when repositioning the blade for the following slice, become entangled with fingers, fall under the blade to be re-cut, etc. Apart from annoyance, productivity for chefs and other professional knife users can be reduced, and risk of injury can be increased.

Less perceptible, except to very skilled knife users, is the sticking friction generated on the side walls of blades when a vacuum is created between the blade face and the food material. This can be a significant component of the force required to drive a blade through food materials, independent of the sharpness of the cutting edge itself.

There have been various attempts to alleviate the effects of sticking friction over the years, including low-friction polymer coatings to release foods. The present invention seeks to avoid coatings that are prone to wear, focusing instead on surface geometry for durability.

One example of innovation in surface geometry features which seek to break the vacuum between blade and food is to use widely interspersed ribs. The present invention utilizes a different approach. The present invention incorporates food and vacuum-releasing lengthwise steps or corrugations into the chisel cutting edge itself, optionally further up the side of the blade, and optionally similar features on the back face of the blade. Smaller surface texture features may be added to eliminate any areas where food could create a significant seal and vacuum.

### BRIEF SUMMARY OF THE INVENTION

The present invention seeks to introduce to knives with improved surface geometry to more effectively reduce vacuum and sticking friction between the blade and the food being sliced.

Because the geometry of the knife of the present invention is too complex for traditional knife “subtractive” grinding methods, the desired geometry can be best achieved by casting (sand casting, metal injection moulding, investment casting, etc.), pressing, forging, extrusion or additive-manufactured (such as 3-D printing), to achieve near net final geometry without the need for further subtractive manufacturing steps, except for refining the cutting edge geometry itself. These manufacturing methods allow features that improve performance, with more complex 3D shapes possible than traditional “subtractive” knife manufacturing methods like grinding or machining. Further economies can be achieved by manufacturing with these methods in one solid piece, with integral blade and handle.

It is a prime object of the present invention to provide a low sticking friction knife blade.

It is another object of the present invention to provide a low sticking friction knife blade with a series of lengthwise extending adjacent corrugations on the surface portion of the blade proximate the cutting edge.

It is another object of the present invention to provide a low sticking friction knife blade wherein each of the corrugations include a substantially planar inclined surface portion extending in a direction away from the blade cutting edge and outwardly from the blade surface.

It is another object of the present invention to provide a low sticking friction knife blade wherein the edge of the inclined surface portion of each corrugation furthest away from the cutting edge forms a lengthwise extending ridge with the adjacent corrugation.

It is another object of the present invention to provide a low sticking friction knife blade wherein a ridge reduces the vacuum and sticking friction between the food being sliced and the blade surface.

It is another object of the present invention to provide a low sticking friction knife blade wherein surface portion of the blade remote from the cutting edge is concave.

It is another object of the present invention to provide a method of manufacturing a low sticking friction knife blade by casting, 3D printing, forging, extrusion, pressing or other additive manufacturing processes.

It is another object of the present invention to provide a method of manufacturing a low sticking friction knife blade in which a metal strip is formed on the side of the blade opposite the corrugated side such that the bulk of the grinding to form the cutting edge of the blade can be done from the side of the blade opposite the corrugated side.

It is another object of the present invention to provide a method of manufacturing a low sticking friction knife blade by removing a metal strip from the blade side opposite the corrugated side of the blade proximate the edge of the blade such that only light grinding or polishing is required on the corrugated side of the blade to finish the cutting edge.

It is another object of the present invention to provide a method of manufacturing a low sticking friction knife blade by creating a concave surface portion on one or both sides of the blade.

It is another object of the present invention to provide a method of manufacturing a low sticking friction knife blade by creating a concave surface portion above the corrugations on the side of the blade opposite the main cutting edge, or on both sides of the blade.

It is another object of the present invention to provide a method of manufacturing a low sticking friction knife blade by applying the above principles to a symmetrical blade, wedge-ground in the traditional manner without a right- or left-sided chisel edge, and with above described corrugations on one or both sides of the blade.

The above objects are achieved by the present invention which relates to a knife for slicing food. The knife includes a handle and a blade. The blade has a tip, a side and a cutting edge. The blade side includes a portion proximate the cutting edge. The proximate side portion includes first and second adjacent corrugations extending between the handle and the blade tip. Each of the first and second corrugations includes an inclined surface with an edge. The edge of the inclined surface of the first corrugation extends outwardly of the inclined surface of the second corrugation forming a lengthwise ridge along the first corrugation. That structure causes food, as it is sliced by the blade, to move across the inclined surface and over the ridge of the first corrugation, to release the vacuum formed between the food and the inclined surface of the second corrugation, reducing the tendency of the food to stick to the blade.

The blade further includes a concave portion remote from the cutting edge of the blade. The concave portion of blade side is situated between the portion proximate the cutting edge and the top edge of the blade.

The blade has an opposite side. The opposite side of the blade any be substantially flat or slightly concave, with or without similar corrugations.

In accordance with another aspect of the present invention, a knife is provided for slicing food. The knife includes a handle and a blade. The blade has a tip, a side and a cutting edge. The blade side includes a portion proximate the cutting edge. The proximate side portion includes a series of adjacent corrugations extending between the handle and the blade tip. Each of the corrugations includes an inclined surface with an edge, with or without a radius along that edge. The edge of the inclined surface of each of the corrugations extends outwardly of the inclined surface of the adjacent corrugation forming a lengthwise ridge along each of the corrugations. That structure causes food, as it is sliced by the blade, to move across the inclined surface and over the ridge of at least one of the corrugations, breaking contact with the blade and introducing air between the blade and food, so as to release the vacuum formed between the food and the inclined surface of the adjacent corrugation, reducing the tendency of the food to stick to said blade.

The blade side may optionally further include a concave portion remote from the cutting edge. The blade has a top edge. The concave portion of the blade side is situated between the portion proximate the cutting edge and the top edge of the blade.

The blade has an opposite side. The opposite side of the blade may be substantially flat or slightly concave.

In accordance with another aspect of the present invention, a method is provided for fabricating a knife blade from a blank. The blank has a side with a corrugated portion and an opposite side. The side with the corrugated portion lacks sufficient flat surfaces which could be used to grip the blank to allow grinding of the blank to create a chisel edge. The method includes the steps of: (a) forming a metal strip on the opposite side of the blank proximate the bottom edge of the blade; (b) grinding down the metal strip on the opposite side of the blank to remove the metal strip, and (c) forming the cutting edge.

The blank may be created by casting, 3D printing, forging, extrusion, printing or another additive manufacturing process.

The blade has a top. The method further includes the step of creating a concave surface portion on the side with the corrugated portion between the corrugated portion and the top of the blade.

The step of creating a slightly concave surface portion is performed by grinding the opposite side of the blade.

The opposite side of the blade may have a corrugated surface portion.

The blade blank includes a handle portion having first and second spaced handle parts. The method further includes the steps of: (a) folding the handle parts into spaced, parallel relation to define a space; and (b) filling the space between the handle parts. The step of filling the space between the handle parts comprises the step of creating a handle insert and situating the handle insert between the folded handle parts.

In accordance with another aspect of the present invention a method for fabricating a knife blade from a blank is provided. The blank includes a side with a corrugated portion and an opposite side. The method includes the steps of: (a) forming a metal strip on the opposite side of the blank proximate the edge of the blade; (b) forming a metal strip on the opposite side of the blank proximate the tip of the blank; (c) grinding down the metal strips on the opposite side of the blank to remove the metal strips, and (d) forming the cutting edge.

The side with the corrugated portion lacks sufficient flat surfaces which could be used to grip the cast blank to allow grinding of the cast blank to create a chisel edge. The step of forming the cutting edge includes the step of forming a chisel edge by lightly grinding the side with the corrugated portion proximate the edge of the blank.

The blade has a top. The method further includes the step of creating a concave surface portion on the side with the corrugated portion, between the corrugated portion and the top of the blade.

The concave surface portion is created during the blank forming manufacturing process.

The blank is formed by casting, 3D printing, forging, extrusion, pressing or another additive manufacturing process

The method further includes the step of grinding the opposite side of the blank.

The opposite side of the blank may be ground flat, or ground to form a slightly concave surface.

The method further includes the step of forging or coining the strip to consolidate voids and better align grain structure in castings.

In accordance with another aspect of the present invention, a method for fabricating the knife blade of the type specified above from a blank. The blank may incorporate handle and blade in a single piece knife, or a blade and tang alone for mounting with a separate handle. If pressed, the handle may be pressed or folded up from the flat sheet. The blade blank has a side with a corrugated portion and an opposite side, or two corrugated sides. Any side with the corrugated portion may lack sufficient flat surfaces which could be used to position and grip the cast blank to allow grinding of the cast blank to create a cutting edge. The method includes the steps of: (a) forming a metal strip on the opposite side of the blank proximate the bottom edge of the blade; (b) nesting the side of the blade with the corrugated portion into a form-fitted holder; and (c) machining or grinding down the metal strip on the opposite side of the blank to remove the metal strip, and (d) finishing the cutting edge to form a chisel edge by grinding or polishing.

The method further includes the step of forging, coining, or cold working either side of the chisel cutting edge.

### BRIEF DESCRIPTION OF THE SEVERAL VIEWS OF DRAWINGS

To these and to such other objects that may hereinafter appear, the present invention relates to a low sticking friction knife blade and methods of manufacturing same as described in detail in the following specification and recited in the annexed claims, taken together with the accompanying drawings, in which like numerals refer to like parts and in which:

FIG. 1 is perspective view of a knife of the present invention with a low sticking asymmetrical blade showing the top edge or spine of the blade and corrugated side of the blade;

FIG. 2 is an elevational view of the of the knife of FIG. 1 showing the corrugated side of the blade;

FIG. 3 is perspective view of a knife of FIG. 1 showing the top or spine of the blade and opposite side of the blade;

FIG. 4 is an elevational view of the of the knife of FIG. 1 showing the opposite side of the blade;

FIG. 5 is a cross-sectional view of the blade of the knife of FIG. 2 as seen along line 5-5 thereof, along with an enlarged portion of the blade showing the details thereof;

FIG. 6 is a perspective view of the knife of the present invention showing the top or spine, rear and opposite side of the blade during the manufacturing process, after the top, bottom and tip metal strips have been formed;

FIG. 7 is a perspective view of the knife of FIG. 6 viewed from the corrugated side, during the manufacturing process, after metal strips have been formed on the top or spine and proximate the tip;

FIG. 8 is a cross-sectional view of the blade during the manufacturing process showing metal strips formed on the opposite side of the blade adjacent the top or spine of the blade and proximate the cutting edge, respectively, along with an enlarged portion of the blade showing the details thereof;

FIG. 9 includes cross-sectional views 9a-9g of blade blanks formed by casting, 3D printing, forging or extrusion or other additive manufacturing process at various stages of the manufacturing process;

FIG. 10 shows cross-sectional views 10a-10i of blade blanks formed by pressing at various stages in the manufacturing process;

FIG. 11 is a view of the various stages of the manufacturing process starting with a blade blank, working the blank to form the surface topography including the metal strips, grinding the blank to remove the metal strips, forming the cutting blade, and the formation of the handle;

FIG. 12 is an elevation view of one side of the blade blank as it would appear prior to formation of the surface topography;

FIG. 13 is an elevation view of the corrugated side of the blade blank after it is formed;

FIG. 14 is an elevation view the corrugated side of the blade blank at the beginning of the grinding process;

FIG. 15 is an elevation view of the blade blank from the corrugated side as the opposite side is being ground;

FIG. 16 is an elevation view of the corrugated side of the blade blank after chisel edge has been formed;

FIG. 17 is an elevation view of the corrugated side of the blade blank after the handle parts are folded; and

FIG. 18 is a perspective view of the blade blank of FIG. 17 showing the handle parts folded and the handle insert exploded.

### DETAILED DESCRIPTION OF THE INVENTION

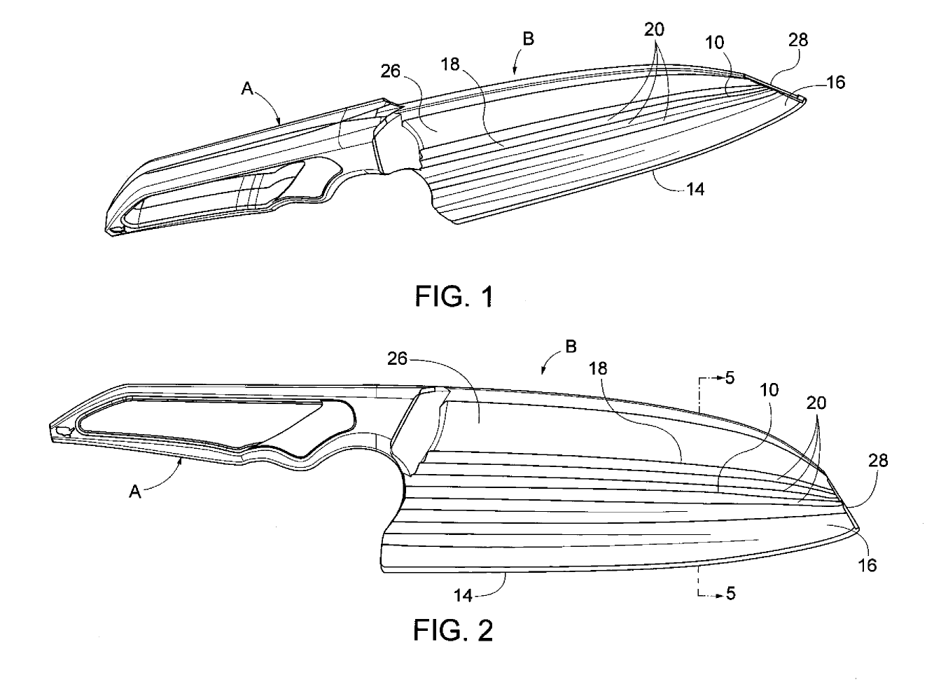

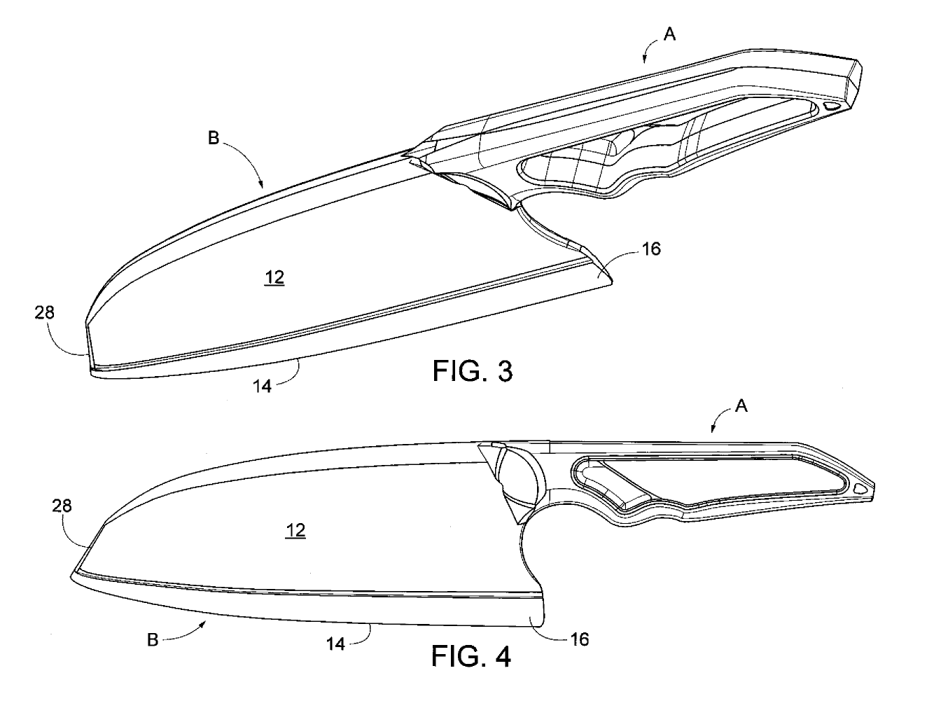

FIGS. 1-4 show a first preferred embodiment of the knife of the present invention. FIGS. 1 and 2 are respectively perspective and elevation views of the knife showing the corrugated side of the blade, which is the side of the blade where the food slice peels way as the blade slices through the food. FIGS. 3 and 4 are respectively perspective and elevation views of the knife showing the opposite side of the blade.

The knife includes a handle, generally designated A, and an integral blade, generally designated B. In this preferred embodiment, the handle and blade are formed together as a single piece. However, the blade may be formed of two pieces, a blade with a tang and a separate handle which is formed around the tang.

Blade B can be made by casting, 3D printing, forging, extrusion or pressing or another additive manufacturing method. A key advantage of such methods is the potential to make significant savings in knife finishing labor, which is the major cost component of knives. These methods allow the blade and handle to be easily combined in a single blank with very little finishing polishing or grinding required, particularly in the case of the chisel-edge blade, where only a light polish on both sides of the edge may be possible. This low labor cost can make this type of knife viable for manufacture in high cost countries where local manufacture is desired by customers.

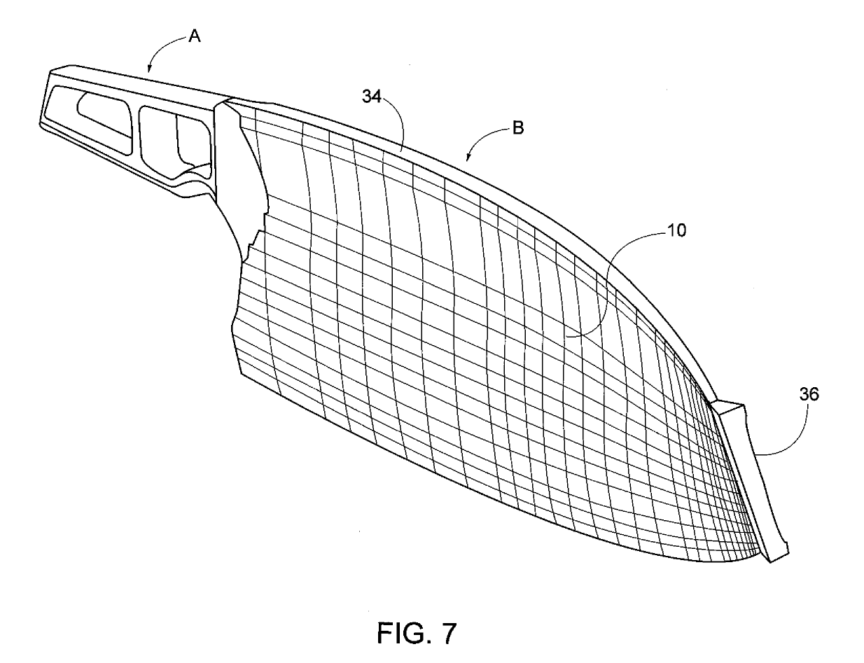

In FIGS. 1-9 and 11-18, Blade B is shown as being asymmetrical. The blade has a corrugated side or surface 10 and an opposite side or surface 12. Side 12 may be flat or slightly concave and may also have a corrugated portion. When both sides have corrugations, the corrugations may be mirror images of each other or may have different contours. The lower edge 14 of blade B has a cutting edge including a chisel edge portion 16.

Side 10 of blade B includes a corrugated surface section 18 located proximate edge portion 16. Section 18 has a plurality of lengthwise corrugations 20. The corrugations extend from handle A toward the tip of the blade. The corrugations are wider (as measured along a line perpendicular to the length of the blade) proximate the handle and taper towards the tip of the blade. Further, the widths of the corrugations may progressively decrease the further the corrugation is away from the cutting edge. The opposite side 12 of the blade may be free of corrugations but may have slightly concave surface or surface portion.

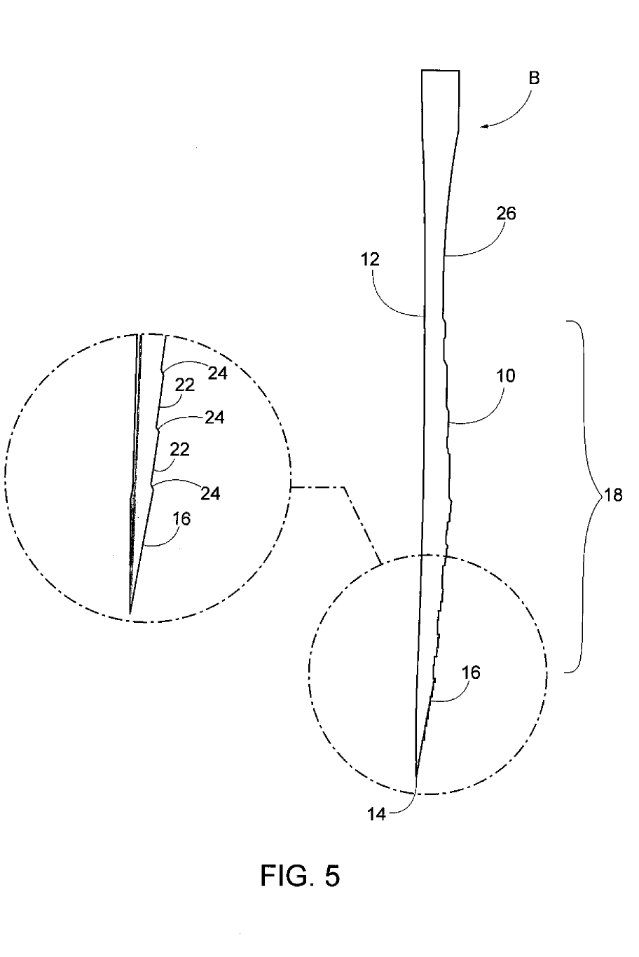

As best seen in FIG. 5, which shows a cross-sectional view of the blade, the chisel edge portion 16, and each of the corrugations 20, has an inclined cutting surface 22 with a narrow angle of food contact. The edge of each the corrugation 20 furthest from edge portion 16 forms a steep aeration ridge 24 which defines a lengthwise channel along the top of the corrugation. Thus, as best seen in the enlarged portion of FIG. 5, the corrugated portion 18 of the blade consists of a series of adjacent corrugations, each of which includes an inclined surface 22 which extends away from edge 14 and outwardly from the blade surface, forming a saw-tooth like pattern. The edges 24 may be sharp or rounded. Each lengthwise channel serves to release the vacuum between the food and the blade surface, by introducing an air channel between the blade and food, as the blade slices the food.

This structure serves to reduce the amount of food sticking to the blade surface, as the food is being sliced by the knife, by releasing the vacuum between the food and blade which causes food to stick to the surface of the blade. As the blade travels downward, the food slides up the gentle slope of the inclined surface 22 of each corrugation, then “falls” off the steep negative edge of the ridge 24. This occurs repeatedly as the knife progresses through the food, each corrugation releasing the vacuum created by the prior cutting surface of each lengthwise corrugation.

This corrugated configuration functions in a way similar to ‘blood grooves’ found in old swords and knives, in that the corrugations create aeration channels in the lengthwise direction, introducing air between the food and blade surface.

It is also possible to form the corrugations to be wavy, stepped or jagged in the lengthwise direction. The ridges of corrugations with those configurations would create the same affect, to release the vacuum between the blade and the food as the knife slices.

It is possible to add small ‘bump’ features or protrusions to the inclined surfaces 22 to enhance the vacuum releasing function. However, such bump features may introduce a disadvantage to the cutting edge when the blade is sharpened down to those features.

One effective “bump” shape includes overlapping rounded fish scales, with the sharp edge facing away from the direction of blade-food travel. Another possible shape may be spherical bumps of sufficient steepness to break the seal of food to blade, while not introducing extra friction from the food striking the angled surface.

The figures show a section 26, located above corrugated blade section 18 and proximate the top edge or spine of the blade, on the corrugated side 10 of the blade. Section 26 has a surface shaped as an aggressive (small radius) concave or hollow to further reduce food contact with the blade and increase air barrier which separates the food from the blade.

The figures also show that lengthwise corrugations 20 can continue, but with increasingly negative angle, as one approaches the tip 28 of the blade. Nominally vertical or angled shallow channels, similar to the scallops of Granton blades, can be added to further release vacuum by introducing air between the food and the blade surface.

The opposite side 12 of blade B (the side of the blade that faces the bulk of the uncut food) may have a substantially flat surface to help steer a straight cut through the food. However, features can be added to reduce vacuum, reduce sticking friction, and aid in easy resharpening of the blade. For example, instead of being flat, the surface of side 12 can be slightly concave, like traditional Japanese sashimi blades, as shown in FIG. 5. Channels and/or ribs may be formed in the surface of side 12 to release air. Further, bumps or other raised features in may be formed in the surface to release vacuum, reduce surface area, and reduce “stiction”, similar to the fish scale configuration noted above.

The unconventional topography of the blade of the present invention creates challenges for traditional blade grinding methods. Those methods have traditional machine fixtures, clamps and vices which require flat surfaces to grip one side of the blade with sufficient force to permit grinding of the opposite face.

The knife of the present invention, because of the way the blade is manufactured, may require specialist holding fixtures to grind the cutting edge in mass production. For small batch production, the geometry of the asymmetrical blade lends itself to manual grinding with the wide chisel edge 16 acting as a guide for polishing the corrugated surface 10 against an abrasive material, while the concave surface of the opposite side 12 can be pressed down on an abrasive surface so that top and bottom edges guide the grinding of the surface of the opposite side. All other surfaces, corrugations and aeration features are left as formed.

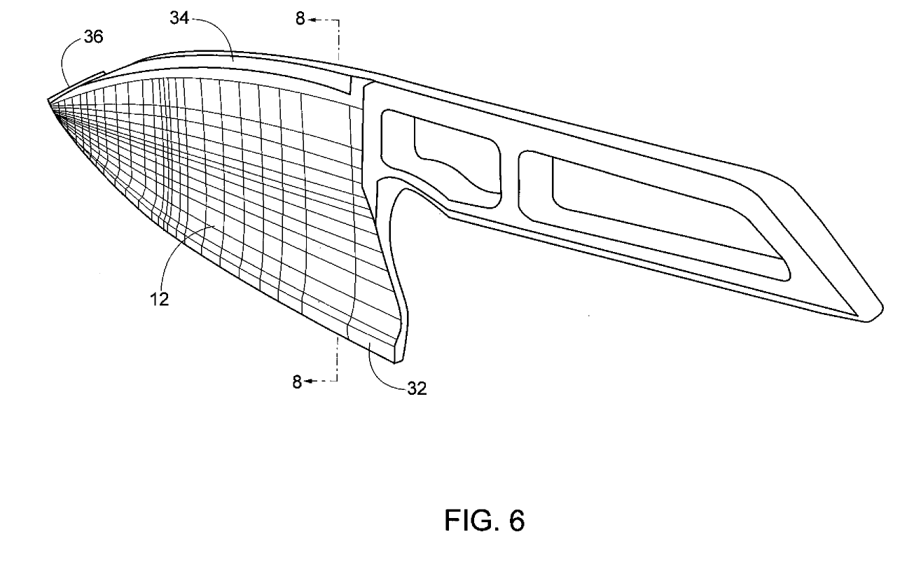

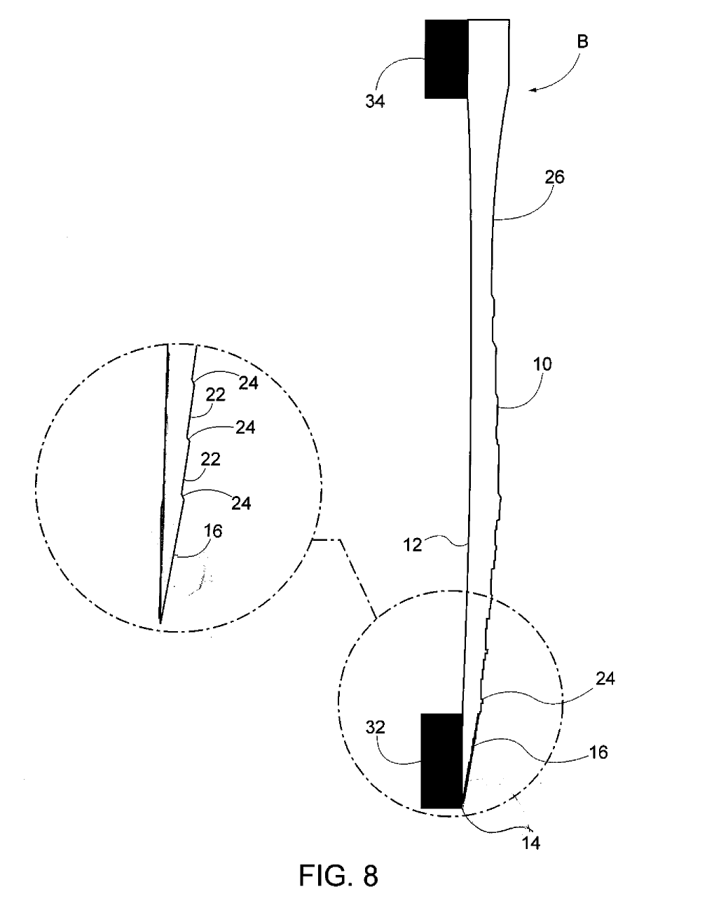

When manufacturing methods are used which normally cannot achieve the fine geometry of thin cutting edges, a strip of metal 32, as seen in FIGS. 6 and 8, may be formed along the bottom edge of the opposite side 12 of the blade. The metal strip is removed by grinding. The bulk of the grinding can be focused on that surface 12, with only a very light finishing grind necessary to finish the chisel edge on the corrugated surface 10. The bulk of the corrugated surface 10 is left “as formed” and may have a concave curved surface portion 26 as shown in the drawings, similar to the back face of traditional Japanese chisel edge knives.

As also seen in FIGS. 6 and 8, a second strip 34 situated along the top or spine of the blade on the opposite surface 12 may aid manual grinding of this surface, balancing out the material to be removed top and bottom, for easy manual guiding of grinding.

The blade tip, being very thin, may also have a metal strip or block 36 added on opposite side 12 when the blade is formed to improve molten metal flow. The strip 36 can be easily ground off as the blade is formed, as with the strips 32 and 34.

FIG. 8 is a cross-sectional view of the blade showing the two metal strips 32, 34 added while the blade is formed to allow for better casting flow, and to aid in easy manual grinding operations of the opposite side surface. A semi-skilled operator could press the opposite surface of the blade down on the two metal strips 32, 34 on an abrasive grinding belt or wheel 38 to remove the metal strips reasonably evenly. The cutting edge 14 is exposed when the metal strip 32 is ground off, leaving very little grinding required on the corrugated surface 10 itself.

In certain circumstances, it may be desirable to forge or coin the metal strips to consolidate voids and better align grain structure in castings.

For automated or machine-assisted grinding or milling of the strips from the opposite side surface of the cutting edge, it may be more effective to eliminate the top strip 34 for better casting flow and so that the blade can be clamped from that top edge. Grinding off strip 32 exposes the cutting edge on the corrugated surface.

Further stability for machine grinding operations can be achieved by machining the topography of the corrugated surface of the blade, in negative in a magnetic base plate, or a regular metal base plate with clamping from the opposite surface, leaving the back of the cutting edge exposed for grinding.

A similar approach to the method above can be achieved if the blade blank is first pressed with all the topography of the corrugated surface, then the bulk of the negative topography is ground off after pressing. A little of the topography can be retained on the opposite side surface for aeration of the blade, like the corrugated surface. Again, very little, if any grinding is required on the corrugated surface after the grinding of the opposite side surface reaches the cutting edge.

A chisel edge blade as shown in the figures will be the simplest style, because almost all machining or grinding of the corrugated surface is eliminated. However, a more conventional wedge-ground symmetrical blade can be achieved by grinding both sides in conventional blade grinding machines after pressing.

Regardless of the method used to form the blank, the knife could be formed as one complete monobloc, with blade and handle as a single piece, as illustrated in the Figures. Alternatively, the knife could be completed by traditional joining of separate handle and blade pieces using normal methods (fixing a separate handle to the blade tang).

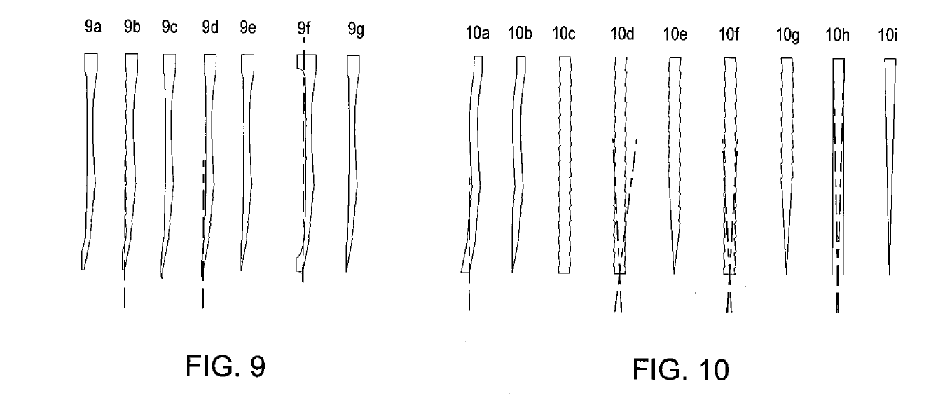

FIG. 9 shows cross-sectional views 9a-9g of blade blanks formed by casting, 3D printing, forging or extrusion or another additive manufacturing method. As noted above, this blank can incorporate a finished handle as one piece.

FIG. 9a shows a blank for right-hand chisel edge blade, with corrugations on right side only. The left side has a flat on the bottom of the cutting edge. As shown, the blade needs machining/grinding down to remove the flat on bottom of cutting edge such that it meets up with right side chisel edge. Polishing or grinding of chisel edge may be necessary if the process used to manufacture the blank leaves a rough surface. If not, very minimal finishing required. For very smooth blanks, only a very light polish required on right side chisel edge is requited to refine the cutting edge. The corrugations on right side of blade function to release the vacuum against the slice being cut away from the bulk of the food (which would be on the left for right-handed knife users).

FIG. 9b shows a blank for a right-hand chisel edge blade, similar to that of FIG. 9a, but with corrugations on both blade sides, and showing the machine/grinding plane. The left side corrugations function to release the vacuum against the bulk of the food.

FIG. 9c shows the blade of FIG. 9a while working the cutting edge to remove voids and align grains in metal. The blade may be hot forged, cold coined, etc.

FIG. 9d shows the blank of FIG. 9a during grinding along the machining/grinding plane to create the cutting edge. Irregular right-side topography may necessitate nesting in a matching negative machined fixture.

FIG. 9e shows the blank of 9c or 9e after machining/grinding on the left side and light grinding/polishing on right side to form the chisel edge.

FIG. 9f shows the optional blank format for aiding manual sharpening operations wherein two metal strips of equal height assist grinding the left side cutting edge by hand. The left side of the blade is pressed flat on a wide finishing belt or grinding wheel to equalize grinding and assist maintaining blade flat. The result is similar to FIG. 9e, except that the left surface is also ground.

FIG. 9g shows the formed blade with corrugations on the right side.

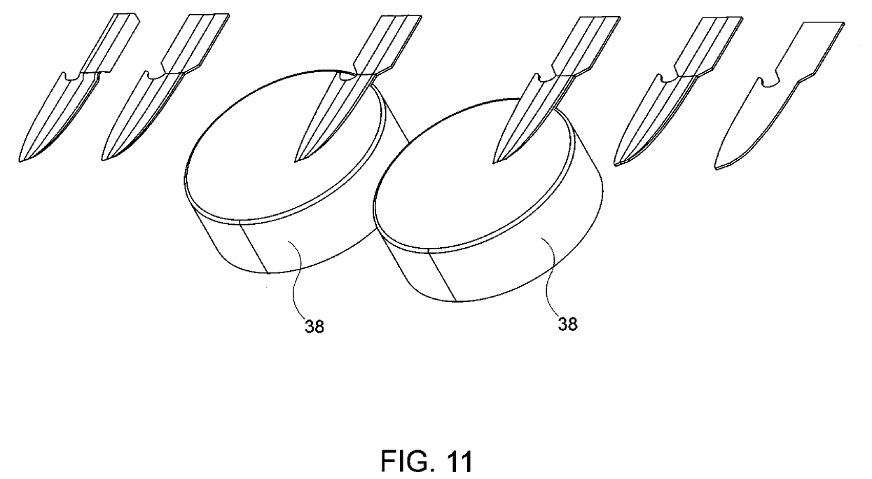

FIG. 10 shows various possible blade contours 10a-10g in cross-section, where the blade blank is formed by pressing.

FIG. 10a shows one potential blade blank cross-section, which could be pressed from a sheet. The blank is shown before grinding/machining forms the sharp cutting edge. Corrugations are necessarily on both sides, with matching pressing dies on each side. The grinding/machining plane necessary to generate flat left side of chisel edge is shown. The plane must deep enough to join with right side chisel edge. This is the only major grinding/machining operation necessary. Thus, this is a very efficient fabrication method compared with traditional wedge grinding of both sides of regular blades, which require significant metal removal from flat blanks.

FIG. 10b shows the blank of 10a after grinding machining with the sharp cutting edge formed. A very sharp edge can then be easily produced by lightly polishing the right-side chisel bevel along the edge.

FIG. 10c shows another pressed blank method, with corrugations on both sides, allowing the possibility of grinding symmetrical blades.

FIG. 10d shows grinding/machining planes for an asymmetrical blade formed by pressing, with broad face on left and chisel cutting edge on right.

FIG. 10e shows the final pressed asymmetrical blade, right-handed.

FIG. 10f shows the same pressed blade blank as 10c, with grinding/machining planes for generating a symmetrical wedge-ground blade.

Hollow grinding of the symmetrical wedge ground blade, or any blade format, is also possible as an option. This would be a concave grind instead of a flat angled bevel, and is common which less expensive mass produced knives.

FIG. 10g shows the blade of 10f after grinding along the machining/grinding planes.

FIG. 10h shows a flat blank before traditional symmetrical wedge-grinding, used in the vast majority of cook's knives. The two grinding planes are shown, with the significant volumes of metal required to be removed from each side of the parallel blank, to finish with a wedge ground blade. A chiseled edge is not normally part of a blade with symmetrical wedge grind.

FIG. 10i shows the final wedge-ground blade formed by wedge grinding along the machine/grinding planes of FIG. 10h.

FIG. 11 shows the various steps in the grinding process when a knife with an integral blade and handle are fabricated. Beginning at the right side of the drawing, the blade blank is die cut from a sheet of metal. The blank is then cast with the corrugations. The opposite side surface of the blank is abraded on a grinding wheel to form the cutting edge and the contour of the non-corrugated surface. The parts of the handle portion of the blank are then folded to form the sides of the handle and an insert is situated between the folded handle parts to complete the handle.

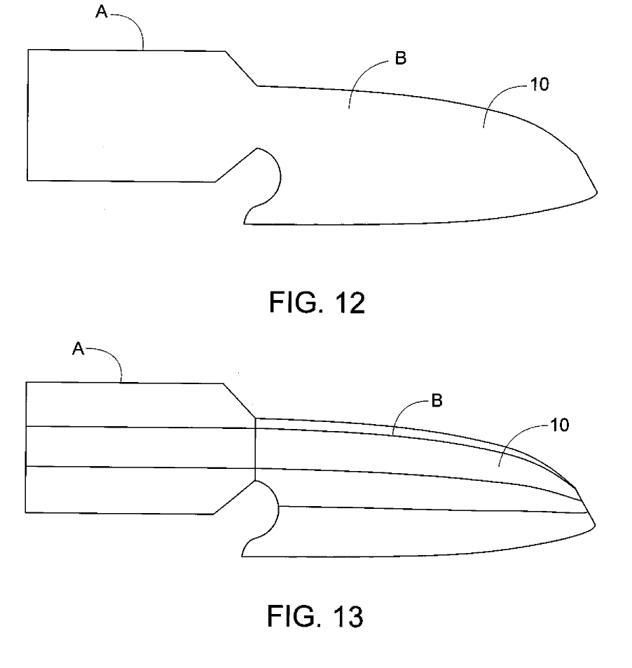

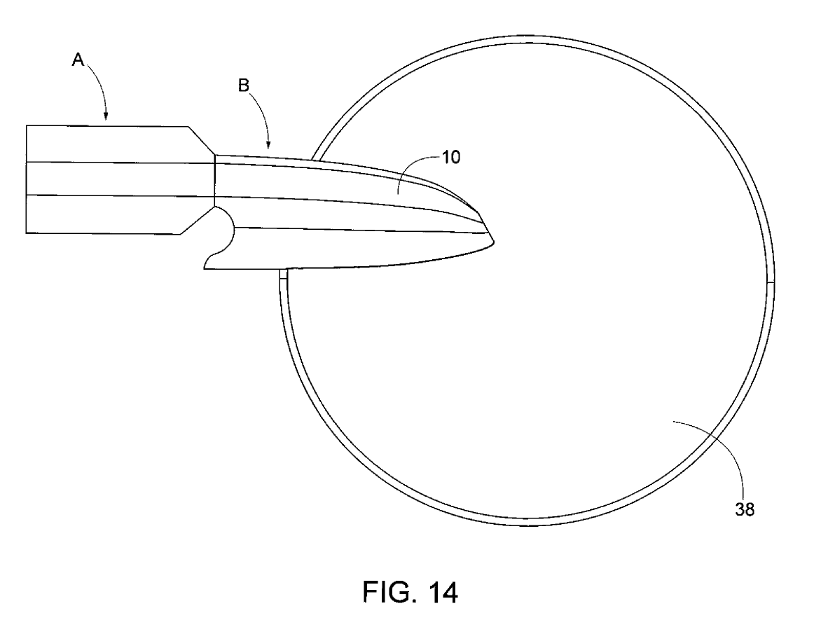

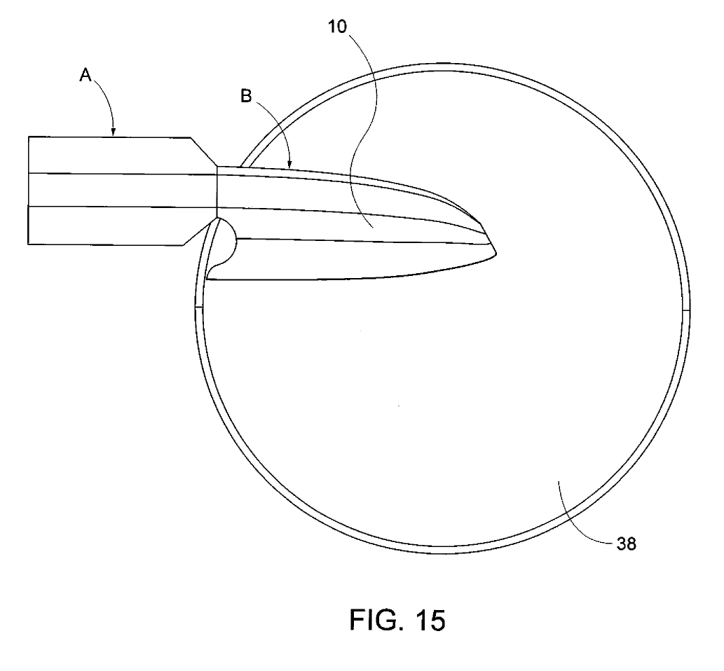

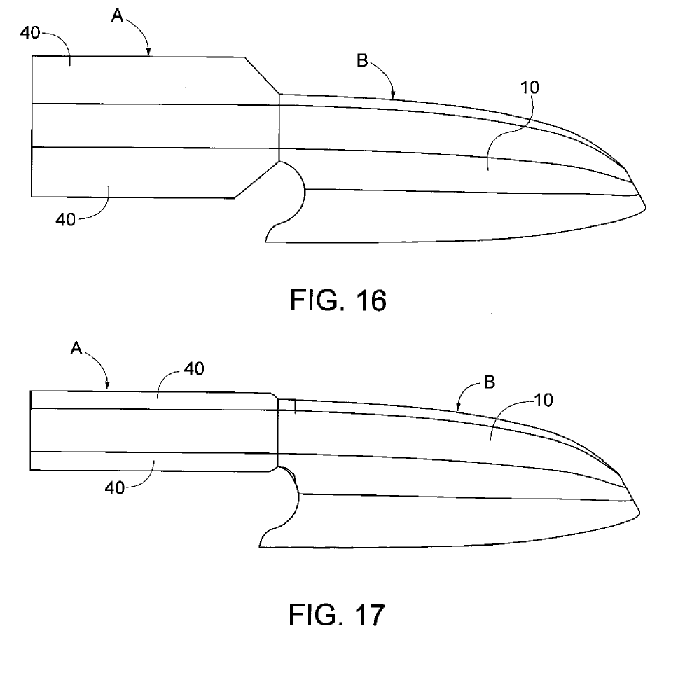

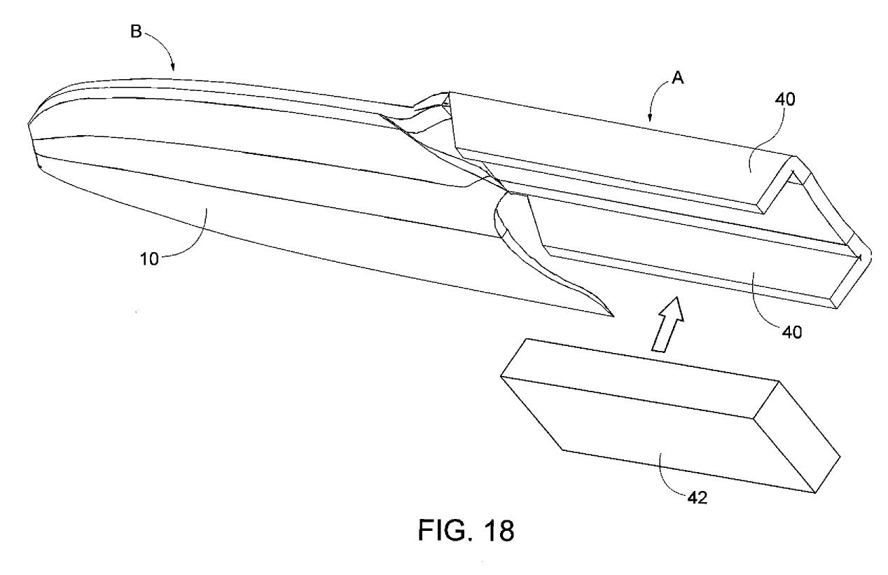

FIG. 12 shows the blade blank before grinding. FIG. 13 shows the blank after the corrugations and other features are formed. FIG. 14 shows the initial portion of the grinding operation. FIG. 15 shows the blank in the final stages of grinding the opposite side. FIG. 16 shows the blank after the grinding operation has been completed. FIG. 17 shows the blank after the handle parts 40 have been folded. FIG. 18 is a perspective view of the knife with the handle parts 40 folded and the handle insert 42 exploded.

As seen in FIGS. 17 and 18, if pressed as a single piece, the handle shape can be folded up from the flat material into a suitable handle with reasonable comfort. Complex folding to close the 4^{th} face could be avoided by filling the cavity with one or more inserts 42, or by casting resin, injection molding, or any suitable method of filling the voids created during folding of the handle.

As will now be appreciated, the knife of the present invention has benefits over regular flat-sided blades in that sticking friction is greatly reduced by the air buffer between blade and food. The cut slices also will have a greatly reduced tendency to adhere to the blade after being cut away from the bulk of the food.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims:

We claim:

1. A knife for slicing food comprising a handle and a blade, said blade having a tip, a side and a cutting edge, said side comprising a portion proximate said cutting edge, said proximate side portion comprising first and second adjacent corrugations extending between said handle and said blade tip, each of said first and second corrugations comprising an inclined surface with an edge, said edge of said inclined surface of said first corrugation extending outwardly beyond said inclined surface of said second corrugation forming a lengthwise ridge along said first corrugation, such that food, as it is sliced by said blade, moves across said inclined surface and over said ridge of said first corrugation, so as to release the vacuum formed between the food and said inclined surface of said second corrugation, reducing the tendency of the food to stick to said blade.

2. The knife of claim 1 wherein said side further comprises a concave portion remote from said cutting edge.

3. The knife of claim 2 wherein said blade has a top edge and wherein said concave portion of said side is situated between said proximate portion and said top edge of said blade.

4. The knife of claim 1 wherein said blade has an opposite side and wherein said opposite side of said blade is substantially flat.

5. The knife of claim 1 wherein said blade has an opposite side and wherein said opposite side of said blade is slightly concave.

6. A knife for slicing food comprising a handle and a blade, said blade having a tip, a side and a cutting edge, said side comprising a portion proximate said cutting edge, said proximate side portion comprising a series of adjacent corrugations extending between said handle and said blade tip, each of said corrugations comprising an inclined surface with an edge, said edge of said inclined surface of each of said corrugations extending outwardly beyond said inclined surface of said adjacent corrugation forming a lengthwise ridge along each of said corrugations, such that food, as it is sliced by said blade, moves across said inclined surface and over said ridge of at least one of said corrugations, so as to release the vacuum formed between the food and said inclined surface of said adjacent corrugation, reducing the tendency of the food to stick to said blade.

7. The knife of claim 6 wherein said side further comprises a concave portion remote from said cutting edge.

8. The knife of claim 7 wherein said blade has a top edge and wherein said concave portion of said side is situated between said proximate portion and said top edge of said blade.

9. The knife of claim 6 wherein said blade has an opposite side and wherein said opposite side of said blade is substantially flat.

10. The knife of claim 6 wherein said blade has an opposite side and wherein said opposite side of said blade is slightly concave.

11. A method for fabricating a knife blade from a blank wherein the blank comprises at least one side having a corrugated portion and an opposite side, said method comprising the steps of:
(a) forming at least one metal strip on the other side of the blank proximate the bottom edge of the blade;
(b) grinding down the metal strip on the other side of the blade blank to remove the metal strip, and
(c) forming a cutting edge.

12. The method of claim 11 wherein the blade side with the corrugated portion lacks sufficient flat surfaces which could be used to grip the blank to allow grinding of the blank to create a chisel edge

13. The method of claim 12 wherein the step of forming a cutting edge comprises the step of lightly grinding the side with the corrugated portion proximate the edge of the blade.

14. The method of claim 11 wherein the blade has a top and further comprising the step of creating a concave surface portion on the side with the corrugated portion, between the corrugated portion and the top of the blade.

15. The method of claim 14 wherein the step of creating a concave surface portion takes place when the blade is formed.

16. The method of claim 11 further comprising the step of grinding said other side of the blade.

17. The method of claim 11 further comprising the step of grinding said other side of the blade to form a slightly concave surface on the other side of the blade.

18. The method of claim 11 further comprising the step of forging or coining the strip to consolidate voids and create better grain alignment.

19. The method of claim 11 wherein said blank is formed by one of the following manufacturing methods: casting, 3D printing, forging, extruding, pressing and another additive manufacturing process.

20. The method of claim 11 further comprising the step of forming a corrugated portion on the other side of the blade.

21. A method for fabricating a knife blade from a blank, wherein the blank has a side with a corrugated portion and an opposite side, and wherein the side with the corrugated portion lacks sufficient flat surfaces which could be used to grip the blank to allow grinding of the blank to create a cutting edge, said method comprising the steps of:
(a) forming a metal strip on the other side of the blank proximate an edge of the blade;
(b) forming a metal strip on the other side of the blank proximate the tip of the blade;
(c) grinding down the metal strips on the other side of the blade blank to remove the metal strips, and
(d) forming a cutting edge.

22. The method of claim 21 wherein the step of forming the cutting edge comprises the step of lightly grinding the side with the corrugated portion proximate the edge of the blade to form a chisel edge.

23. The method of claim 21 wherein the blade has a top edge and further comprising the step of creating a concave surface portion on the side with the corrugated portion between the corrugated portion and the top edge of the blade.

24. The method of claim 23 wherein the step of creating a concave surface portion takes place when the blank is formed.

25. The method of claim 21 further comprising the step of grinding the other side of the blank.

26. The method of claim 21 further comprising the step of grinding the other side of the blade to form a slightly concave surface.

27. The method of claim 21 wherein the blank is formed by one of the following manufacturing methods: casting, 3D printing, forging, extruding, pressing and another additive manufacturing process.

28. A method for fabricating the knife blade of claim 1 from a blank, wherein the blank has a side with a corrugated portion and an opposite side, comprising the following steps:
(a) forming at least one metal strip on the opposite side of the blank proximate the bottom edge of the blade;
(b) grinding down the metal strip on the opposite side of the blade blank to remove the metal strip, and
(c) forming a cutting edge.

29. The method of claim 28 wherein the blade side with the corrugated portion lacks sufficient flat surfaces which could be used to grip the blank to allow grinding of the blank to create a chisel edge.

30. The method of claim 29 wherein the step of forming a cutting edge comprises the step of lightly grinding the side with the corrugated portion proximate the edge of the blade.

31. The method of claim 28 wherein the blade has a top edge and further comprising the step of creating a concave surface portion on the side with the corrugated portion, between the corrugated portion and the top edge of the blade.

32. The method of claim 31 wherein the step of creating a concave surface portion takes place when the blade is formed.

33. The method of claim 28 further comprising the step of grinding said opposite side of the blade.

34. The method of claim 28 further comprising the step of grinding said opposite side of the blade to form a slightly concave surface on the other side of the blade.

35. The method of claim 28 further comprising the step of forging or coining the strip to consolidate voids and create better grain alignment.

36. The method of claim 28 wherein said blank is formed by one of the following manufacturing methods: casting, 3D printing, forging, extruding, pressing and another additive manufacturing process.

37. The method of claim 28 further comprising the step of forming a corrugated portion on the opposite side of the blade.

38. The method of claim 28 wherein the blade blank includes a handle portion with first and second spaced handle parts and wherein the method further comprises the steps of:
(a) folding the handle parts into spaced, parallel relation to define a space; and
(b) filling the space between the handle parts.

39. The method of claim 38 wherein the step of filling the space between the handle parts comprises the steps of:
(a) forming a handle insert; and
(b) inserting the handle insert between the handle parts.

40. A method for fabricating the knife blade from a blank formed by an additive manufacturing process, the blank comprising a blade portion and a handle portion, wherein the blank has at least one side with a corrugated portion and an opposite side, the method comprising the steps of:
(a) forming a metal strip on the opposite side of the blank proximate the bottom edge of the blade;
(b) nesting the corrugated side of the blade into a form-fitted holder;
(c) machining or grinding down the metal strip on the non-chisel edge side of the blade blank to remove the metal strip, and
(d) finishing the chisel edge by grinding or polishing.

41. The method of claim 40 further comprising the step of forging, coining, or cold working either side of the blade to form a chisel cutting edge;

42. The method of claim 40 wherein the handle portion and a blade portion are formed of a single piece.

43. The method of claim 40 wherein the handle portion comprises a tang for mounting with a separate handle

44. The method of claim 40 wherein the blank is formed by pressing, and wherein the handle portion is pressed or folded up from a flat sheet.

45. The method of claim 40 wherein both sides of the blank have corrugations.

46. The method of claim 40 wherein the side with the corrugated portion lacks sufficient flat surfaces which could be used to position and grip the cast blank to allow grinding of the cast blank to create a chisel edge.
